(19) United States
(12) Patent Application Publication
(10) Pub. No.: US 2008/0099558 A1
(43) Pub. Date: May 1, 2008

(54) Card reader with multiple slots

(75) Inventors: Ching-Chung Hung, Pingzhen City (TW); Yu-Chi Peng, Pingzhen City (TW)

Correspondence Address: TROXELL LAW OFFICE PLLC;SUITE 1404, 5205 LEESBURG PIKE, FALLS CHURCH, VA, 22041, US

(73) Assignee: Dadafab Systems Inc.

(21) Appl. No.: 11/590,905

(22) Filed: Nov. 1, 2006

(51) Int. Cl. G06K 7/01

(52) U.S. Cl. 235/440

(57) ABSTRACT

A card reader with multiple slots to convert data stored in electronic cards in different format into the interface format of Express Card™ and to output the converted data to a computer includes an insulation casing, two slots, one Express Card™ connector, and data relay unit to convert the data storage format of an electronic card into the interface format of Express Card™ and to output the converted data through the Express Card™ connector; each slot being divided into multiple terminal sets to respectively connect to multiple electronic cards for reducing the space of the card reader, facilitating portability, and better adapting to expansion medium used by mobile commerce or traveler.

### BACKGROUND OF THE INVENTION

(a) Field of the Invention

The present invention is related to an improved construction of a card reader with multiple slots, and more particularly, to a single insulation casing segregated into two slots with a partitioning wall to receive insertion of one or a plurality of electronic card while converting data storage format of the electronic card into the interface format of Express Card™.

(b) Description of the Prior Art

To upgrade data storage volume, electronic cards of exclusive format are externally crated for electronic products including digital camera and digital video camera for replacement in time. Electronic cards in different formats including Memory Stick (MS), Memory Stick PRO (MS PRO), eXtreme Digital (xD), Secure Digital (SD), Multi Media Card (MMC), Reduced-Sized Multi Media Card (RS MMC), Multi Media Card plus (MMC plus), Multi Media Card mobile (MMC mobile), Memory Stick Duo (MS Duo) and Mini Secure Digital (mini SD) are generally available in the market. To cope with the compact design for electronic products, electronic cards in even smaller size have been introduced into the market in recent years, e.g., MICRO Multi Media Card (MICRO MMC), MICRO Memory Stick (MICRO MS) and MICRO Secure Digital (MICRO SD); accordingly, card reader adaptable to those cards for data readout must be provided with card insertion mechanism in the format compliant with that of the electronic card to connect the electronic card to the electric circuit for data transmission.

However, as electronic cards differ in width and length depending on the format, a card reader with a single slot is not applicable to any electronic card in different format. As a result, the practicability and utility of the card reader are compromised. Therefore, design of the card reader of new generation is heading for a universal one that is compatible to various formats of electronic cards and it is expected that with the best simplified structural design and the most reliable structural strength to maintain accuracy of the insertion and the stability of the connection between the card reader and the card.

Each manufacturer of digital product gives every effort to promote its in-house developed memory card. Note Book computer (NB) and Personal digital assistant (PDA) have the Personal Computer Memory Card International Association (PCMCIA) specification published earliest in 1989 as the mainstream; and practically all NBs in the market are provided with one or a plurality of PCMCIA slot. Three types of thickness are defined for each PCMCIA slot, respectively, Type I, Type II, and Type III essentially applied to memory card, NB interface card, sound card, digital card, networking deices, and devices externally connected to hard disk. PCMCIA further formulates in recent years the Express Card™ interface format. Therefore, should reading terminal interfaces of various types of memory card be integrated in a more compact space to meet expansion needs of the Express Card™ for easy portability of NB or portable electronic facilities, the card reader should answer more to the current trend. However, the Express Card reader is usually provided with only one slot to give limited practicability and utility since it fails to allow use of electronic cards in different formats.

### SUMMARY OF THE INVENTION

The primary purpose of the present invention is to provide an improved structure of card reader with multiple slots in one that is capable of reading ten or more of data storage interfaces integrated in two slots of a same insulation casing and finally outputting the data via the interface of Express Card™.

To achieve the purpose, the present invention to convert and output data stored in electronic cards of different formats to the format of Express Card™ interface includes an insulation casing, an Express Card™ connector, and a data conversion unit to convert and output the data storage format of an electronic card into Express Card™ interface format through the connector. A portioning wall is disposed in the insulation casing to define a first slot and a second slot. The first slot is further divided into a first, a second, and a third terminal sets; and the second slot, a fourth, and a fifth terminal sets for respective connection by xD, SD, MMC, RS MMC, MM C plus, MMC mobile, MS Duo, and Mini SD electronic cards while all terminal sets are integrated in the same insulation casing.

### BRIEF DESCRIPTION OF THE DRAWINGS

FIG. 1 is a perspective view of a preferred embodiment of the present invention.

FIG. 2 is an exploded view of the preferred embodiment of the present invention.

FIG. 3 is a perspective view of a local part of the preferred embodiment of the present invention.

FIG. 4 is a perspective view of another preferred embodiment of the present invention.

FIG. 5 is perspective view of a local part of another preferred embodiment of the present invention

### DETAILED DESCRIPTION OF THE PREFERRED EMBODIMENTS

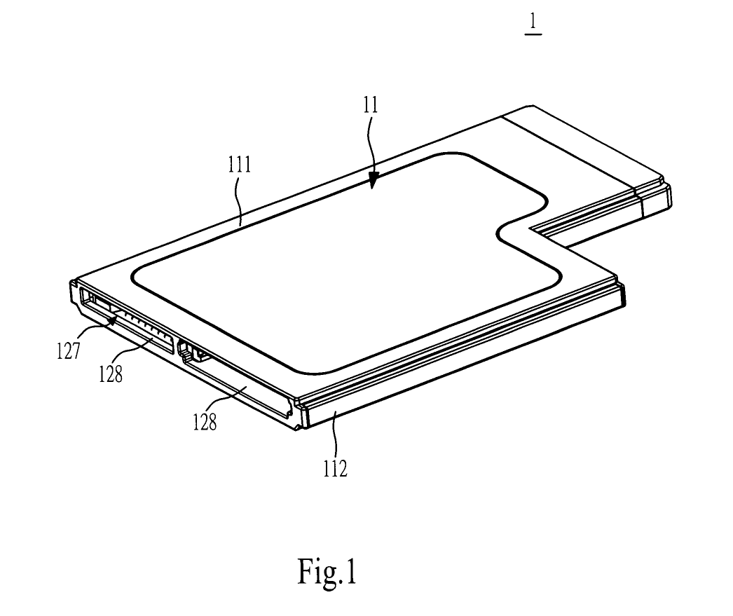

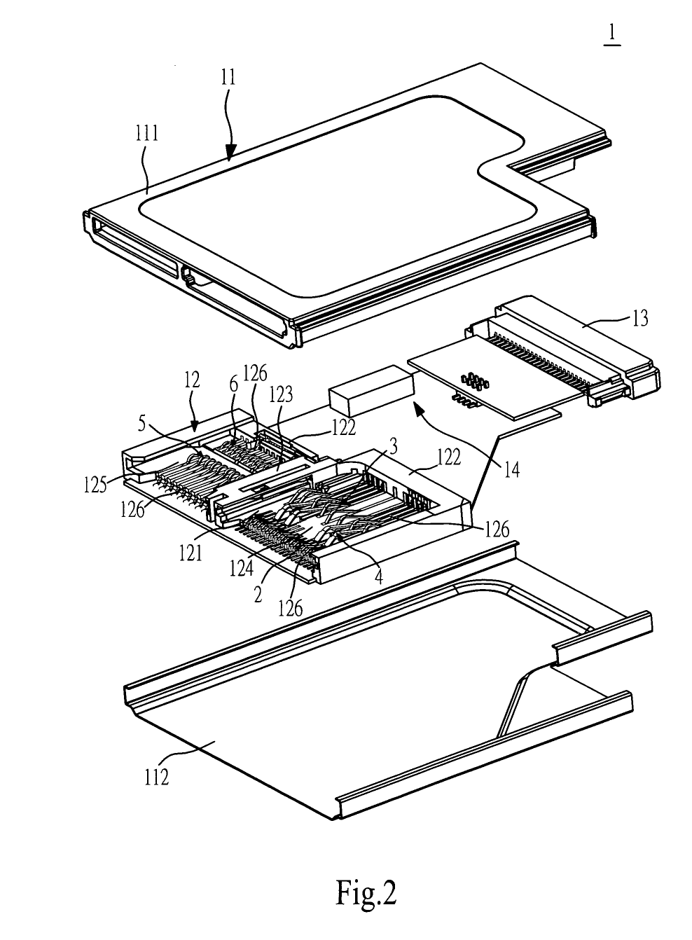

Referring to FIGS. 1 and 2, a preferred embodiment of the present invention includes a card reader 1 comprised of an outer casing 11, an insulation casing 12, an Express Card™ connector 13, and a data relay unit 14. Wherein, the outer casing 11 is approximately related to a rectangular box plastic casing including an upper casing 111 and a lower casing 112 connected to each other, and both of the upper and the lower casings 111, 112 when connected to each other defines a space to accommodate other elements.

The insulation casing 12 includes a base plate 121 and a sidewall 122 extending upward from the outer edge of the base plate 121. The insulation casing 12 contains a portioning wall 123 to divide it into a first slot 124 and a second slot 125. The first slot 124 is further divided into a first, a second, and a third terminal sets 2, 3, 4; and the second slot 125, a fourth and a fifth terminal sets 5, 6. All these terminal sets are disposed in a terminal sink 126. A socket side 127 is disposed to the insulation casing 12 and is located at the base plate 121 on the opposite side of the sidewall 122. Two sockets 128 respectively connected through both slots are disposed on the socket side 127.

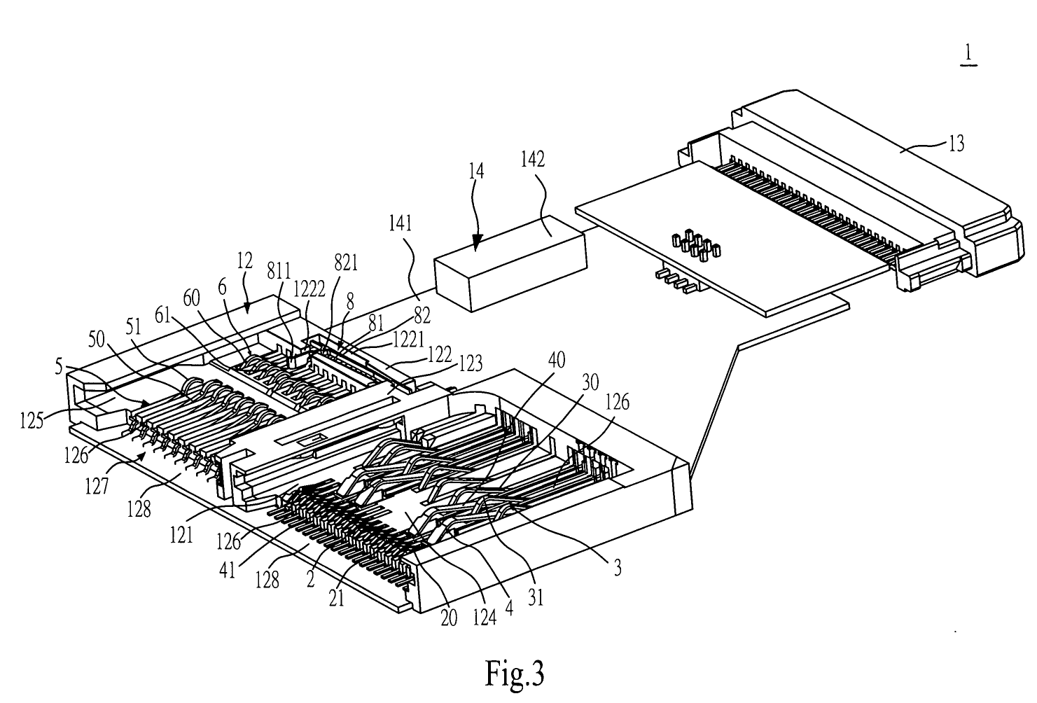

As illustrated in FIG. 3, those five terminal sets includes the first, the second, and the third terminal sets 2, 3, 4 disposed in each corresponding terminal sink 126 in the first slot 124, and the fourth and the fifth terminal sets disposed in each corresponding terminal sink 126 in the second slot 125. Each conduction terminal 20, 30, 40, 50, 60 of each terminal set is provided with fingers 21, 31, 41, 51, 61 for connecting electronic cards inserted to the slots 124, 125.

Those multiple terminal sinks 126 of the first terminal set 2 are disposed on the base plate 121 adjacent to the socket side 127. Multiple fingers 21 of each conduction terminal 20 are provided to connect an xD electronic card (not illustrated).

Those multiple terminal sinks 126 of the second terminal set 3 are segregated and disposed on the sidewall 122. Multiple fingers 31 of each conduction terminal 30 of the second terminal set 3 are provided to connect an MMC electronic card, an RS MMC electronic card or an SD electronic card (not illustrated).

Those multiple terminal sinks 126 of the third terminal set 4 are segregated and disposed on the sidewall 122. Multiple fingers 41 of each conduction terminal 40 of the third terminal set 4 are provided in conjunction with the second terminal set 3 to connect an MMC plus electronic card or an MMC mobile electronic card (not illustrated).

Those multiple terminal sinks 126 of the fourth terminal set 5 are disposed on the base plate adjacent to the socket side 127. Multiple fingers 51 of each conduction terminal 50 of the fourth terminal set 5 are provided to connect an MS Duo electronic card (not illustrated).

Those multiple terminal sinks 126 of the fifth terminal set 6 are segregated and disposed on the sidewall 122. Multiple fingers 61 of each conduction terminal 60 of the fifth terminal set 6 are provided to connect a Mini SD electronic card (not illustrated).

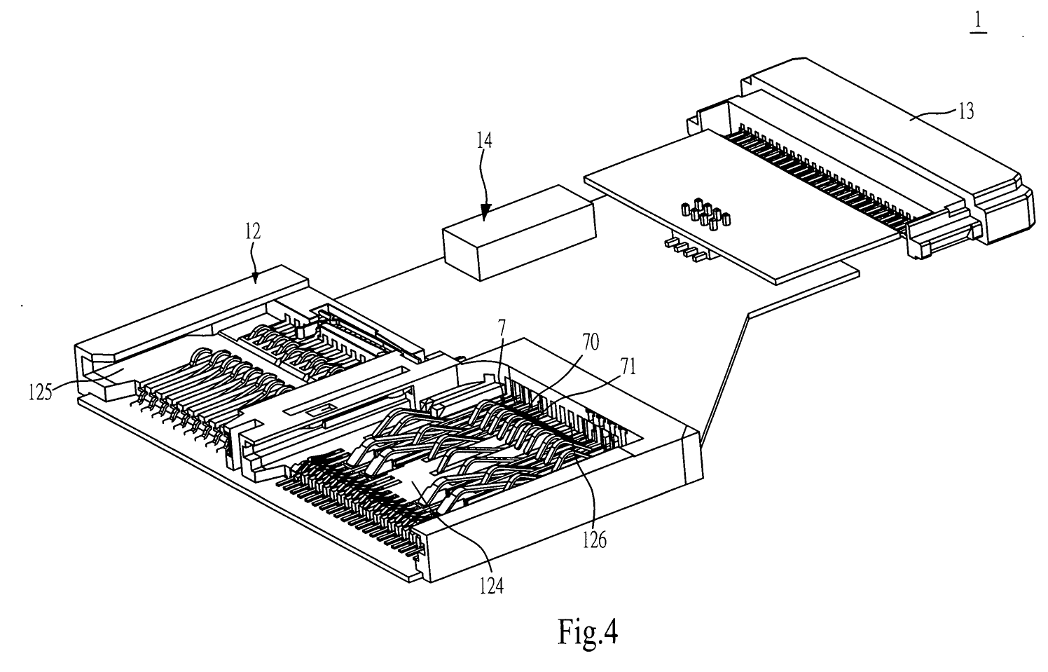

The first slot 124 is further disposed with a sixth terminal set 7 as illustrated in FIG. 4. Multiple terminal sinks 126 of the sixth terminal set 7 are segregated and disposed on the sidewall 122. Multiple fingers 71 of each conduction terminal 70 of the sixth terminal set 7 are provided to connect an MS electronic card or an MS PRO electronic card (not illustrated). Therefore, all the terminal sets disposed in the first and the second slots 124, 125.

A detection terminal set 8 is disposed in the second slot 125 in a direction perpendicular to the conduction terminal 70 of the sixth terminal set 7 and includes a first and a second detection terminals 81, 82 disposed in parallel adjacent to the front and the rear of the detection terminal set 8. In the preferred embodiment, an accommodation slot 1221 to receive the detection terminal set 8 is further disposed in the sidewall 122. An opening 1222 is disposed to the accommodation slot 1221 and the first detection terminal 81 is further disposed with a retaining end 811 that is curved and extends into the second slot 125. A retaining portion 821 is provided protruding from the second detection terminal 82 at where in relation to the retaining end 811 of the first detection terminal 81. The function of the detection terminal set 8 is to detect whether an electronic card inserted to the second slot 125 is secured in position against those fingers. When the electronic card is inserted into the second slot 125, it touches the retaining end 811 and the retaining portion 821 in sequence while transmitting the contract signals to a circuit board. Of course, the detection terminal set may be disposed in the first slot 124 or two detection terminal sets may be respectively disposed in the first and the second slots 124, 125.

The Express Card™ connector 13 is provided in relation to an expansion connector provided on a Notebook; however, this connector 13 for not being included in the characteristics of this preferred embodiment is not elaborated herein.

The data relay unit 14 is provided with a circuit board 141 and a control chip 142 soldered to the circuit board 141. Both ends of the circuit board 141 are respectively coupled to those terminal sets 2˜7 of the insulation casing 12 and the Express Card™ connector 13. The control chip 142 is capable of picking up data transmitted from those terminal sets 2˜7 and convert the data for output in Express Card™ interface format.

It is to e noted that this preferred embodiment is capable of integrating eight or ten types of electronic card and interfaces related to their series without having to separately provide those terminal sets 2˜7. The present invention accommodates all those terminal sets 2˜7 in different slots of the same insulation casing 12 thus to reduce the space of the entire card reader. Meanwhile the present invention is capable of coping with change in data storage format to perfectly meet the current appeal for a compact size. The preferred embodiment is particularly suitable for adaptation to a computer for expansion purpose. To facilitate portability, miniaturization is a must.

As described above, the prevent invention includes eight or ten types of electronic card terminal sets 2˜7 otherwise to be separately provide in different slots within the same insulation case 12 to integral for reduced space, easier portability, and providing the ability to convert ten data formats into that can be applied by Express Card™ interface for expansion purpose of a Notebook.

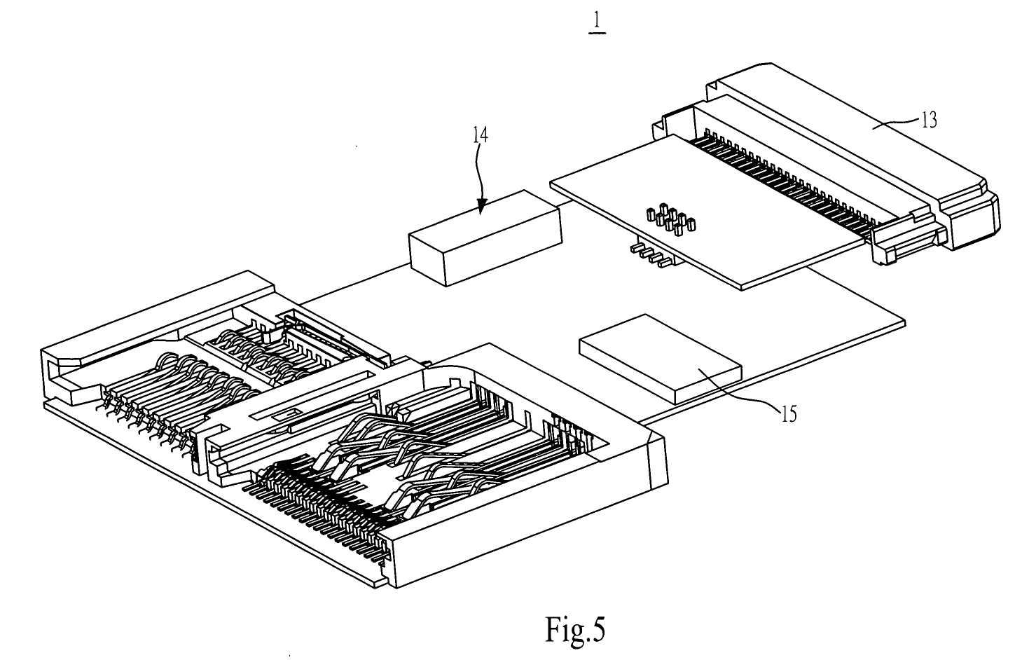

Furthermore, the card reader 1 contains a Universal Serial Bus (USB) connector 15 as illustrated in FIG. 5 corresponding to a USB plug disposed to a Notebook for the card reader 1 to be adapted to, so that the card reader 15 may have the USB connector 15 as the format for signal transmission.

The prevent invention provides an improved structure of a card reader, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. An improved structure for a card reader with multiple slots adapted to a circuit board and provided for insertion by electronic cards in different formats comprising an insulation casing containing a portioning wall to divide the insulation casing into multiple slots; an Express Card™ connector; and a data relay unit; the slot being provided with multiple terminal sets for insertion by various electronic cards in different formats; and the data relay unit converting the data format received by the terminal set into that of Express Card™ interface for output.

2. The card reader as claimed in claim 1, wherein the insulation casing is divided into a first slot and a second slot by means of the portioning wall.

3. The card reader as claimed in claim 1, wherein the terminal set includes multiple conduction terminals each disposed with multiple fingers for the insertion of connection by an electronic card.

4. The card reader as claimed in claim 2, wherein the first slot includes a first, a second, a third, and a fourth terminal sets with each terminal set disposed in a terminal sink provided in the first slot; the second slot includes a fifth and a sixth terminal sets with each terminal set disposed in another terminal sink provided in the second slot; a socket side is disposed on the insulation casing; and two sockets respectively connecting through the socket side are disposed on the socket side.

5. The card reader as claimed in claim 4, wherein the first slot is further disposed with a seventh terminal set to connect an MS or an MS Pro electronic card.

6. The card reader as claimed in claim 4, wherein the first terminal set connects to an xD electronic card; the second terminal set, to an MMC electronic card, SD electronic card or RS MMC electronic card; the third terminal set being incorporated with the second terminal set, to an MMC plus electronic card or an MMC mobile electronic card; the fourth terminal set, to an MS Duo electronic card; and the fifth terminal set, to a Mini SD electronic card.

7. The card reader as claimed in claim 4, wherein the insulation casing includes a base plate; a sidewall extending upward from the base plate; and the socket side is located at the base plate on the other side opposite to the sidewall.

8. The card reader as claimed in claim 7, wherein the terminal sink of the first and the fourth terminal sets is disposed on the base plate adjacent to the socket side; and the terminal sink of the second, the third, and the fifth terminal sets are disposed on the sidewall.

9. The card reader as claimed in claim 4, wherein a detection terminal set is disposed to the slot in a direction perpendicular to conduction terminal of the terminal set and comprises a first detection terminal and a second detection terminal.

10. The card reader as claimed in claim 4, wherein the second terminal set is further connected to an SD electronic card.

11. The card reader as claimed in claim 1, wherein the card reader further comprises an outer casing to accommodate the circuit board, the insulation casing, the Express Card™ connector and the data relay unit.

12. The card reader as claimed in claim 11, wherein the outer casing is a plastic casing.

13. The card reader as claimed in claim 1, wherein the card reader further comprises a USB connector.
